(19) United States
(12) Patent Application Publication
(10) Pub. No.: US 2016/0313707 A1
(43) Pub. Date: Oct. 27, 2016

(54) METHOD AND APPARATUS FOR ADJUSTMENT OF ANALOG MOVEMENT HANDS OF TIMEPIECE

(71) Applicant: REENA LIMITED, Hong Kong SAR (CN)

(72) Inventor: WAI-KIN LAW, HONG KONG SAR (CN)

(73) Assignee: REENA LIMITED, HONG KONG SAR (CN)

(21) Appl. No.: 14/831,393

(22) Filed: Aug. 20, 2015

(30) Foreign Application Priority Data
Apr. 21, 2015 (HK) 15103872.0

(51) Int. Cl. G04R 20/00; G04B 17/00; G04C 11/00

(52) U.S. Cl. CPC G04R 20/00; G04C 11/00; G04B 17/00

(57) ABSTRACT

A method for adjustment of analog movement hands of a timepiece and apparatus for adjustment of analog movement hands of a timepiece designed according to the method. The method includes the steps of: a pairing step to pair a timepiece with a mobile device through a wireless signal; an extraction step to acquire the position time of the timepiece movement; a calculation step to conduct comparison calculation according to the position time of the timepiece movement and the time of the mobile device; and a syncing step to control a movement mode of the timepiece movement according to a differential value of the comparison calculation.

### TECHNICAL FIELD

The present invention relates to a method for adjustment of analog movement hands of a timepiece, and more particularly, to a method and apparatus for adjustment of analog movement hands of a timepiece.

### BACKGROUND

In the related art, the time precision of a common clock is affected by such factors as an internal mechanical structure or the self frequency error of quartz crystal; moreover, with the influence of an ambient temperature change, for example, the temperature change causes changes to the performances of lubricating oil and a balance spring in the clock, the time performance of the clock is changed; therefore, a larger time deviation will usually occur after the clock is used for a period of time, while the user of the clock rarely calibrates the time deviation personally. However, it will waste a lot of time to return the clock back to a manufacturer for calibration or deliver the clock to a professional technician for calibration, and expensive service charges may be possibly required.

In the market, it appears with a method and a device for calibrating timepiece movement. The clock device includes a time calculation unit configured to calculate time, a receiving unit configured to receive a calibration signal, and a detection unit configured to detect the position of the timepiece movement, wherein the detection unit is configured to detect the position time of the timepiece movement and receives and inputs the calibration signal through the receiving unit, and drives the timepiece movement to rotate so as to finish the time calibration after a calibration position acquired is calculated out by the time calculation unit. However, the device is complicated, and the detection unit must be used; therefore, the cost is relatively higher.

### SUMMARY

In view of the technical problem of poor performances of the method and apparatus for adjustment of analog movement hands of a timepiece in the related art as well as the problem of high production cost, it is necessary to provide a preferable method and apparatus for adjustment of analog movement hands of a timepiece and a clock device with low production cost.

The present invention specifically employs a technical solution as follows.

A method and apparatus for adjustment of analog movement hands of a timepiece includes: a pairing step to pair a timepiece with a mobile device through a wireless signal; an extraction step to acquire the position time of the timepiece movement; a calculation step to conduct comparison calculation according to the position time of the timepiece movement and the time of the mobile device; and a syncing step to control a movement mode of the timepiece movement according to a differential value of the comparison calculation.

In a further optional implementation manner of the present invention, the extraction step further includes transmitting the position time of the timepiece movement acquired to the mobile device after stopping the movement of the timepiece and acquiring the position time of the timepiece movement.

In a further optional implementation manner of the present invention, the calculation step further includes:

conducting comparison according to the position time of the timepiece movement T2 acquired and the time of the mobile device T1, and calculating a differential value ΔT between the position time of the timepiece movement acquired and the time of the mobile device according to a formula ΔT=T2−T1, wherein the differential value ΔT is a time error of each unit time. In a further optional implementation manner of the present invention, the movement mode of the timepiece movement includes:

a normal mode, the timepiece movement moving according to a default speed;

a static mode, the timepiece movement entering a movement stopping state; and

a syncing mode, the timepiece movement entering a quick rotation state; and the syncing step further includes:

generating a timepiece movement control instruction according to the differential value ΔT; when the differential value ΔT is equal to or greater than a predetermined value, conducting the timepiece movement control instruction and controlling to switch the movement mode of the timepiece movement to the syncing mode, and controlling to switch the movement mode of the timepiece movement from the syncing mode to the normal mode after the movement of the timepiece movement is consistent with the time T1; and

when the differential value ΔT is less than the predetermined value, conducting the timepiece movement control instruction and controlling to switch the movement mode of the timepiece movement to the static mode, and controlling to switch the movement mode of the timepiece movement from the static mode to the normal mode after waiting for a time value equal to the differential value ΔT.

In a further optional implementation manner of the present invention, the method further includes a storage step to store the data of the position time of the timepiece movement acquired. In a further optional implementation manner of the present invention, the syncing step further includes:

emitting, by the timepiece, a notification signal when conducting the timepiece movement control instruction; and meanwhile, emitting, by the timepiece, a notification signal again when the movement mode of the timepiece movement is restored to the normal mode; the notification signal being presented by at least one manner of sound, device vibration or flashing light.

An apparatus for adjustment of analog movement hands of a timepiece, includes a pairing module configured to pair a timepiece with a mobile device through a wireless signal; an extraction module configured to acquire the position time of the timepiece movement; a calculation module configured to conduct comparison calculation according to the position time of the timepiece movement and the time of the mobile device; and a syncing module configured to control a movement mode of the timepiece movement according to a differential value of the comparison calculation.

In a further optional implementation manner of the present invention, the extraction module is further configured to transmit the position time of the timepiece movement acquired to the mobile device after stopping the movement of the timepiece movement and acquiring the position time of the timepiece movement.

In a further optional implementation manner of the present invention, the calculation module conducts comparison according to the position time of the timepiece movement T2 acquired and the time of the mobile device T1, and calculates a differential value ΔT between the position time of the timepiece movement acquired and the time of the mobile device according to a formula ΔT=T2-T1, wherein the differential value ΔT is a time error of each unit time.

In a further optional implementation manner of the present invention, the movement mode of the timepiece movement includes:

a normal mode, the timepiece movement moving according to a default speed;

a static mode, the timepiece movement entering a movement stopping state; and

a syncing mode, the timepiece movement entering a quick rotation state; and the syncing module is configured to generate a timepiece movement control instruction according to the differential value ΔT;

when the differential value ΔT is equal to or greater than a predetermined value, conduct the timepiece movement control instruction and control to switch the movement mode of the timepiece movement to the syncing mode, and control to switch the movement mode of the timepiece movement from the syncing mode to the normal mode after the movement of the timepiece movement is consistent with the time T1; and when the differential value ΔT is less than the predetermined value, conduct the timepiece movement control instruction and control to switch the movement mode of the timepiece movement to the static mode, and control to switch the movement mode of the timepiece movement from the static mode to the normal mode after waiting for a time value equal to the differential value ΔT.

In a further optional implementation manner of the present invention the apparatus for adjustment of analog movement hands of a timepiece further includes a storage module configured to store the data of the position time of the timepiece movement acquired.

In a further optional implementation manner of the present invention, the syncing module is further configured to: emit, by the timepiece, a notification signal when conducting the timepiece movement control instruction; and meanwhile, emit, by the timepiece, a notification signal again when the movement mode of the timepiece movement is restored to the normal mode; the notification signal being presented by at least one manner of sound, device vibration or flashing light.

Compared with the related art, the present invention has the main advantageous effects that: according to the method and apparatus for adjustment of analog movement hands of a timepiece of the present invention, the timepiece is paired with the mobile device, and the comparison calculation is conducted after acquiring the position time of the timepiece movement and the time of the mobile device; therefore, the differential value between the time of the timepiece movement and the time of the mobile device can be acquired, and the movement mode of the timepiece movement can be controlled to adjust the movement hands rotating and be calibrated to sync with a correct time. Since the apparatus for adjustment of analog movement hands of a timepiece according to the present invention are no longer required with any extra detection unit, the production costs of the method and apparatus for adjustment of analog movement hands of a timepiece according to the present invention are lower. The timepiece can be automatically calibrated through a time calibration step as long as the user pairs the timepiece with the mobile device through a wireless signal for once.

### BRIEF DESCRIPTION OF THE DRAWINGS

FIG. 1 is a block diagram showing a method and apparatus for adjustment of analog movement hands of a timepiece according to a first embodiment of the invention;

FIG. 2 is a block diagram showing modules of an apparatus for adjustment of analog movement hands of a timepiece according to the first embodiment to a fifth embodiment of the invention;

FIG. 3 is a block diagram showing a method and apparatus for adjustment of analog movement hands of a timepiece according to a second embodiment of the invention;

FIG. 4 is a block diagram showing a method and apparatus for adjustment of analog movement hands of a timepiece according to a third embodiment of the invention;

FIG. 5 is a block diagram showing a method and apparatus for adjustment of analog movement hands of a timepiece according to a fourth embodiment of the invention;

FIG. 6 is a block diagram showing a method and apparatus for adjustment of analog movement hands of a timepiece according to a fifth embodiment of the invention;

FIG. 7 is a block diagram showing a method and apparatus for adjustment of analog movement hands of a timepiece according to a sixth embodiment of the invention;

FIG. 8 is a block diagram showing a method and apparatus for adjustment of analog movement hands of a timepiece according to a seventh embodiment of the invention;

FIG. 9 is a block diagram showing modules of an apparatus for adjustment of analog movement hands of a timepiece according to the sixth embodiment to the seventh embodiment of the invention; and

FIG. 10 is a block diagram showing an operation flow of a method and apparatus for adjustment of analog movement hands of a timepiece according to the invention.

### DETAILED DESCRIPTION

In order to make the objects, technical solutions and advantages of the present invention more clear, the present invention will be further described in details hereinafter with reference to the drawings and embodiments. It should be understood that the specific embodiments described herein are only for explanation of the present invention only, but are not intended to limit the present invention.

### First Embodiment

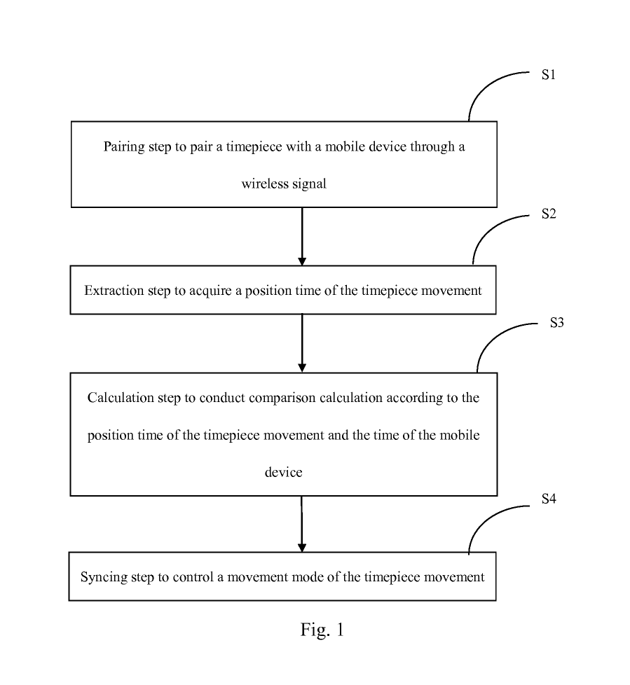

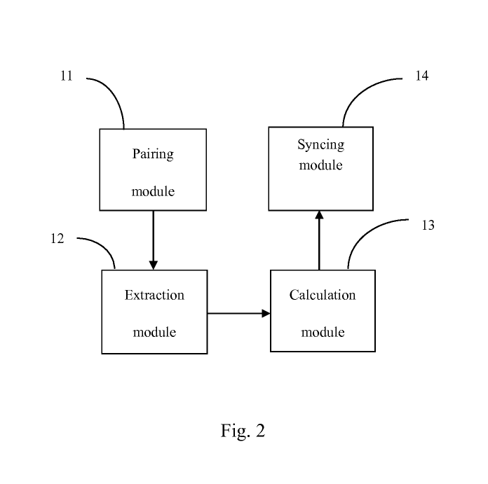

Referring to FIG. 1. and FIG. 2. FIG. 1 is a block diagram showing a method and apparatus for adjustment of analog movement hands of a timepiece according to the embodiment, wherein the method includes the following steps.

Step S1 is a pairing step to pair a timepiece with a mobile device through a wireless signal.

Step S2 is an extraction step to acquire the position time of the timepiece movement.

Step S3 is a calculation step to conduct comparison calculation according to the position time of the timepiece movement and the time of the mobile device.

Step S4 is a syncing step to control a movement mode of the timepiece movement according to a differential value calculated after step S3 is conducted.

FIG. 2 is a block diagram showing modules of an apparatus for adjustment of analog movement hands of a timepiece according to the embodiment. The apparatus for adjustment of analog movement hands of a timepiece according to the embodiment includes a pairing module 11, an extraction module 12, a calculation module 13 and a syncing module 14.

Firstly, step 51 is conducted, wherein the pairing module 11 pairs the timepiece with a mobile device through a wireless signal. After step 51 is completed, the extraction module 12 acquires the position time of the timepiece movement, compares the position time of the timepiece movement with the time of the mobile device, calculates a differential value of the time through the calculation module 13, and controls a movement mode of the timepiece movement through the syncing module 14 according to a differential value calculated after step S3 is completely conducted.

### Second Embodiment

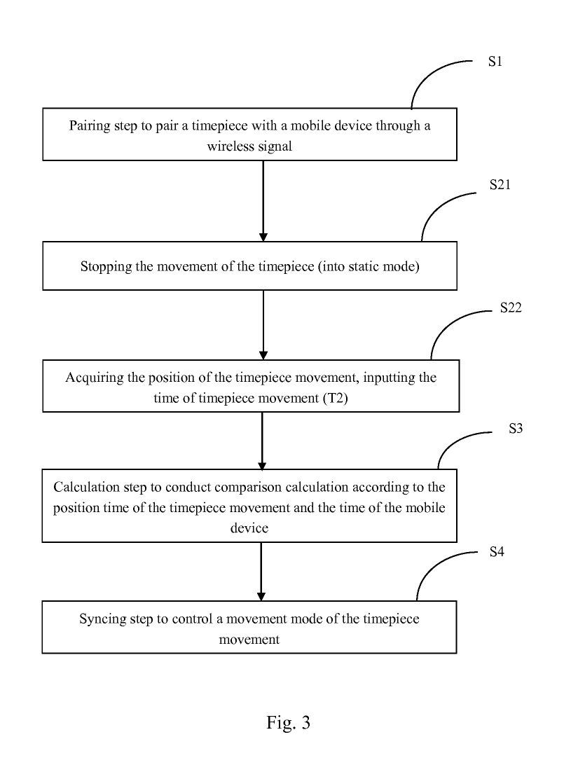

Referring to FIG. 2 and FIG. 3, the method and apparatus for adjustment of analog movement hands of a timepiece according to the embodiment includes the following steps.

S1 is a pairing step: the pairing module 11 of the timepiece is configured to pair a timepiece with a mobile device through a wireless signal.

In the embodiment, the timepiece is paired with a smartphone through a Bluetooth signal. The pairing flow between the smartphone and the apparatus is as follows:

a mobile application and a Bluetooth signal of the smartphone are enabled to emit a signal for standby pairing detection;

the smartphone starts scanning and searches Bluetooth apparatus (timepiece) available for pairing; and

the pairing module 11 of the timepiece is enabled through a button on the timepiece, and the timepiece will buzz once. When the button is pressed for two seconds, the timepiece will beep twice transitorily and quickly. During this period, the timepiece will broadcast the Bluetooth ID thereof quickly and transitorily to complete the pairing process in a short period of time. It usually takes a few seconds for the entire pairing process, and the timepiece will beep thrice transitorily and quickly after the pairing is successful. If a matched apparatus cannot be found in 20 seconds, the timepiece will stop searching a Bluetooth apparatus (smartphone) for pairing.

Step S2 is an extraction step: After step 51 is completely conducted, the position time of the timepiece movement is required to be acquired through the extraction module 12. To be specific, the timepiece movement of the embodiment will be stopped firstly (Step S21), the residence position time of the timepiece movement is detected visually or read through a camera lens of the mobile device, and the position time of the timepiece movement acquired is inputted to the mobile device.

In order to accurately acquire the residence position time of the timepiece movement, in the embodiment, the camera lens focus in a position opposite to the front side of the timepiece movement, acquires the residence position of the timepiece movement and calculate the residence time of the timepiece, and input the time to the mobile device (Step S22).

Step S3 is a calculation step: when implementing the above-mentioned step, comparison is conducted via the calculation module 13 according to the position time of the timepiece movement (T2) acquired and inputted to the mobile device and the time of the mobile device (T1), and a differential value ΔT between the position time of the timepiece movement acquired and the time of the mobile device is calculated.

Step S4 is a syncing step: a movement mode of the timepiece movement is controlled through the syncing module 14 according to the differential value ΔT calculated after step S3 is completely conducted.

### Third Embodiment

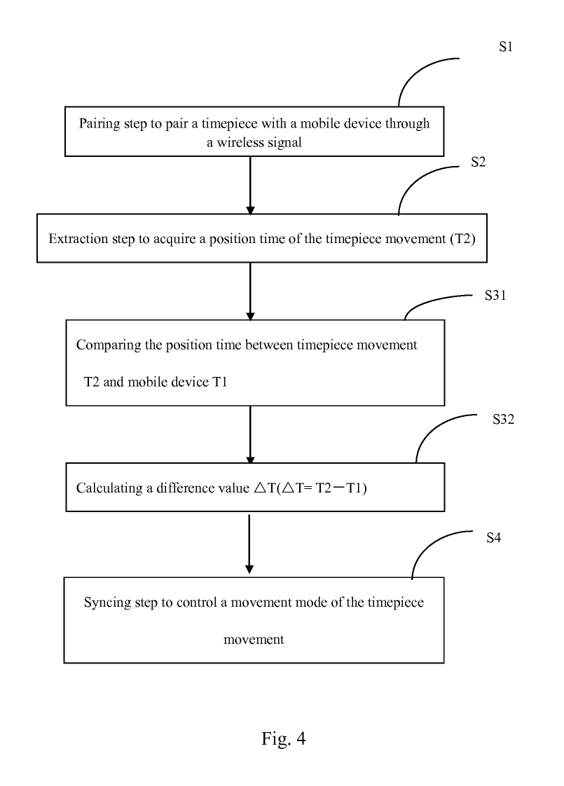

Referring to FIG. 2 and FIG. 4, the method and apparatus for adjustment of analog movement hands of a timepiece according to the embodiment includes the following steps.

S1 is a pairing step: same to the pairing step (S1) in the second embodiment.

Step S2 is an extraction step: after step S1 is completely conducted, the position time of the timepiece movement is required to be acquired through the extraction module 12, and then the position time of the timepiece movement acquired is inputted to the mobile device.

Step S3 is a calculation step: when implementing the above-mentioned step, comparison is conducted through the calculation module 13 according to the position time of the timepiece movement T2 acquired and inputted to the mobile device the time of the mobile device T1 (Step S31), and a differential value ΔT between the position time of the timepiece movement acquired and the time of the mobile device is calculated through the calculation module 13 according to a formula ΔT=T2−T1 (Step S32), wherein the differential value ΔT is a time error of each unit time. For example, it is assumed that the position time of the timepiece movement T2 is 10:20, the time of the mobile device T1 is 10:28, then the differential value ΔT calculated according to the formula ΔT=T2−T1 is 8 minutes.

Step S4 is a syncing step: A movement mode of the timepiece movement is controlled through the syncing module 14 according to the differential value calculated after step S3 is completely conducted.

### Fourth Embodiment

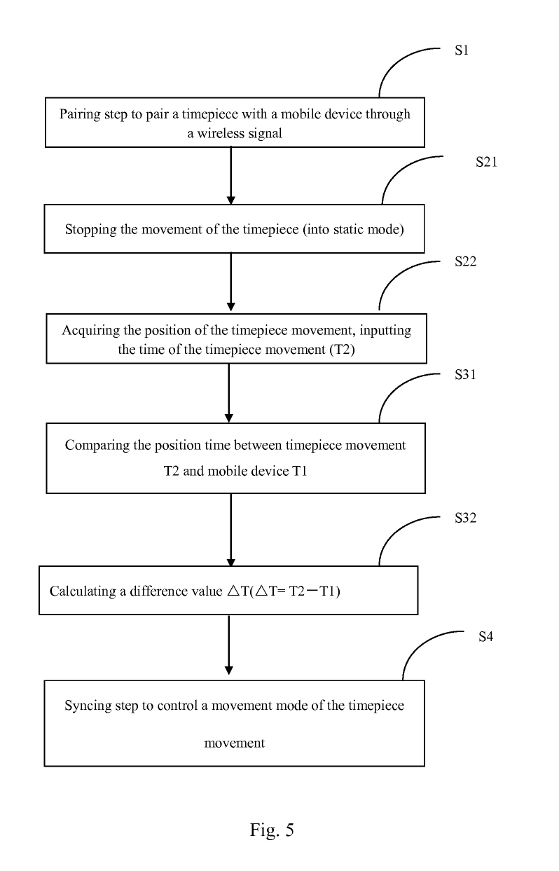

Referring to FIG. 2 and FIG. 5, the method and apparatus for adjustment of analog movement hands of a timepiece according to the embodiment includes the following steps.

S1 is a pairing step: the pairing module 11 of the timepiece is configured to pair a timepiece with a mobile device through a wireless signal.

In the embodiment, the timepiece is paired with a smartphone through a Bluetooth signal.

The pairing flow between the smartphone and the device is as follows:

a mobile application and a Bluetooth of the smartphone are enabled to emit a signal for standby pairing detection;

the smartphone starts scanning and searches a Bluetooth device (timepiece) available for pairing; and the pairing module 11 of the timepiece is enabled through a button on the timepiece, and the timepiece will buzz once. When the button is pressed for two seconds, the timepiece will beep twice transitorily and quickly. During this period, the timepiece will broadcast the Bluetooth ID thereof quickly and transitorily to complete the pairing process in a short period of time. It usually takes a few seconds for the entire pairing process, and the timepiece will beep thrice transitorily and quickly after the pairing is successful. If a matched device cannot be found in 20 seconds, the timepiece will stop searching a Bluetooth device (smartphone) available for pairing.

Step S2 is an extraction step: After step S1 is completely conducted, the position time of the timepiece movement is required to be acquired through the extraction module 12. To be specific, the timepiece movement of the embodiment will be stopped firstly (Step S21), the residence position time of the timepiece movement is detected visually or read through a camera lens of the mobile device, and the position time of the timepiece movement acquired is inputted to the mobile device.

In order to accurately acquire the residence position time of the timepiece movement, in the embodiment, the camera lens focus in a position opposite to the front side of the timepiece movement, acquires the residence position of the timepiece movement and calculate the residence time of the timepiece, and input the time to the mobile device (Step S22).

Step S3 is a calculation step: when implementing the above-mentioned step, comparison is conducted through the calculation module 13 according to the position time of the timepiece movement T2 acquired and inputted to the mobile device the time of the mobile device T1 (Step S31), and a differential value ΔT between the position time of the timepiece movement acquired and the time of the mobile device is calculated through the calculation module 13 according to a formula ΔT=T2−T1 (Step S32), wherein the differential value ΔT is a time error of each unit time. For example, it is assumed that the position time of the timepiece movement T2 is 10:20, the time of the mobile device T1 is 10:28, then the differential value ΔT calculated according to the formula ΔT=T2-T1 is 8 minutes.

Step S4 is a syncing step: a movement mode of the timepiece movement is controlled through the syncing module 14 according to the differential value calculated after step S3 is completely conducted.

### Fifth Embodiment

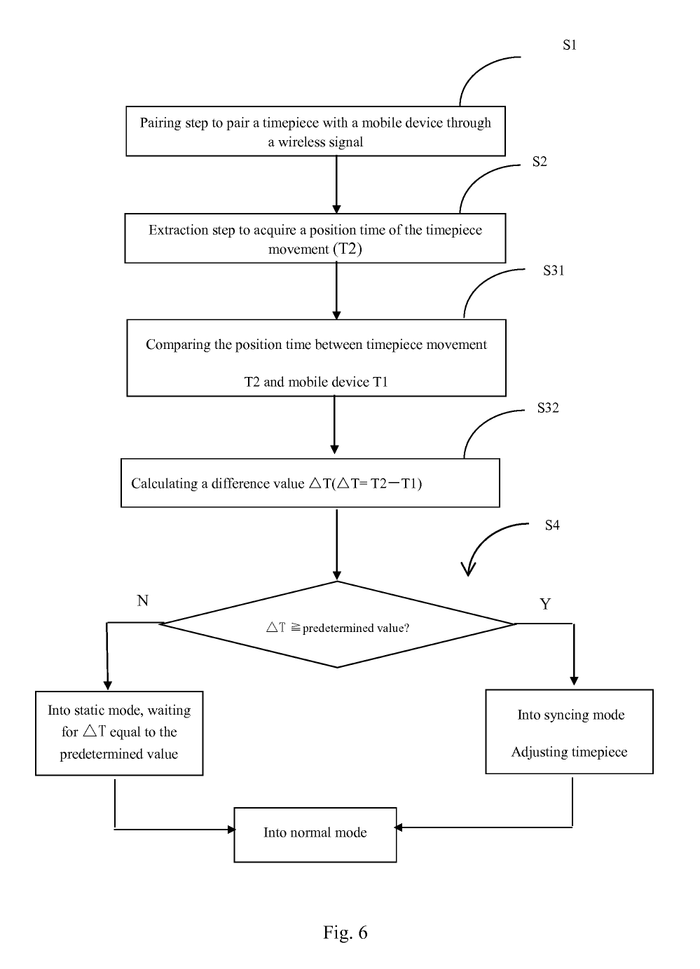

Referring to FIG. 2 and FIG. 6, the method and apparatus for adjustment of analog movement hands of a timepiece according to the embodiment includes the following steps.

S1 is a pairing step: the pairing module 11 of the timepiece is configured to pair a timepiece with a mobile device through a wireless signal.

In the embodiment, the timepiece is paired with a smartphone through a Bluetooth signal.

The pairing flow between the smartphone and the device is as follows:

a mobile application and a Bluetooth of the smartphone are enabled to emit a signal for standby pairing detection;

the smartphone starts scanning and searches a Bluetooth device (timepiece) available for pairing; and

the pairing module 11 of the timepiece is enabled through a button on the timepiece, and the timepiece will buzz once. When the button is pressed for two seconds, the timepiece will beep twice transitorily and quickly. During this period, the timepiece will broadcast the Bluetooth ID thereof quickly and transitorily to complete the pairing process in a short period of time. It usually takes a few seconds for the entire pairing process, and the timepiece will beep thrice transitorily and quickly after the pairing is successful. If a matched device cannot be found in 20 seconds, the timepiece will stop searching a Bluetooth device (smartphone) available for pairing.

Step S2 is an extraction step: after step 51 is completely conducted, the residence position time of the timepiece movement is required to be acquired through the extraction module 12. To be specific, the timepiece movement of the embodiment will be stopped firstly, the residence position time of the timepiece movement is detected visually or read through a camera lens of the mobile device, and the position time of the timepiece movement acquired is inputted to the mobile device.

In order to accurately acquire the residence position time of the timepiece movement, in the embodiment, the camera lens focus in a position opposite to the front side of the timepiece movement, acquires the residence position of the timepiece movement and calculate the residence time of the timepiece, and input the time to the mobile device.

Step S3 is a calculation step: when implementing the above-mentioned step, comparison is conducted through the calculation module 13 according to the position time of the timepiece movement T2 acquired and inputted to the mobile device the time of the mobile device T1 (Step S31), and a differential value ΔT between the position time of the timepiece movement acquired and the time of the mobile device is calculated through the calculation module 13 according to a formula ΔT=T2−T1 (Step S32), wherein the differential value ΔT is a time error of each unit time. For example, it is assumed that the position time of the timepiece movement T2 is 10:20, the time of the mobile device T1 is 10:28, then the differential value ΔT calculated according to the formula ΔT=T2−T1 is 8 minutes.

Step S4 is a syncing step: a movement mode of the timepiece movement is controlled through the syncing module 14 according to the differential value calculated after step S3 is completely conducted.

To be specific, the movement mode of the timepiece movement of the embodiment firstly includes: a normal mode, the timepiece movement moving according to a default speed; a static mode, the timepiece movement entering a movement stopping state; and a syncing mode, the timepiece movement entering a quick rotation state.

the timepiece of the embodiment generates a timepiece movement control instruction according to the numerical value of the differential value ΔT.

when the differential value ΔT is equal to or greater than a predetermined value, the timepiece movement control instruction is conducted and the syncing module 14 controls to switch the movement mode of the timepiece movement to the syncing mode, and controls to switch the movement mode of the timepiece movement from the syncing mode to the normal mode after the movement of the timepiece movement is consistent with the time T1. In the embodiment, the predetermined value is 10 minutes. For example, it is assumed that the position time of the timepiece movement T2 is 10:20, the time of the mobile device T1 is 10:38, then the differential value ΔT calculated according to the formula ΔT=T2−T1 is 18 minutes. Since the differential value ΔT of the comparison calculation is greater than the predetermined value, the syncing module 14 controls to switch the movement mode of the timepiece movement to the syncing mode, and the timepiece movement enters a quick rotating state, so that the syncing module 14 controls to switch the movement mode of the timepiece movement from the syncing mode to the normal mode after the timepiece movement moves clockwise from the time position 10:20 (T2) before switching to the syncing mode to a time position consistent with the time position 10:38 (T1). At this moment, the timepiece movement moves at a default speed.

When the differential value ΔT is less than the predetermined value, the timepiece movement control instruction is conducted, and the syncing module 14 controls to switch the movement mode of the timepiece movement to the static mode, and control to switch the movement mode of the timepiece movement from the static mode to the normal mode after waiting for a time value equal to the differential value ΔT, and the timepiece emits a notification signal again at the same time. In the embodiment, the predetermined value is 10 minutes. For example, it is assumed that the position time of the timepiece movement T2 is 10:33, the time of the mobile device T1 is 10:28, then the differential value ΔT calculated according to the formula ΔT=T2−T1 is 5 minutes. Since the differential value ΔT of the comparison calculation is less than the predetermined value, the syncing module 14 controls to switch the movement mode of the timepiece movement to the static mode. At this moment, the timepiece enters a movement stopping state. After the syncing module 14 waits for a time modulus (5 min) equal to the differential value ΔT, the time of the mobile device T1 at this moment is 10:33. The syncing module 14 controls to switch the movement mode of the timepiece movement from the static mode to the normal mode, so that the timepiece movement rotates at a default speed.

### Sixth Embodiment

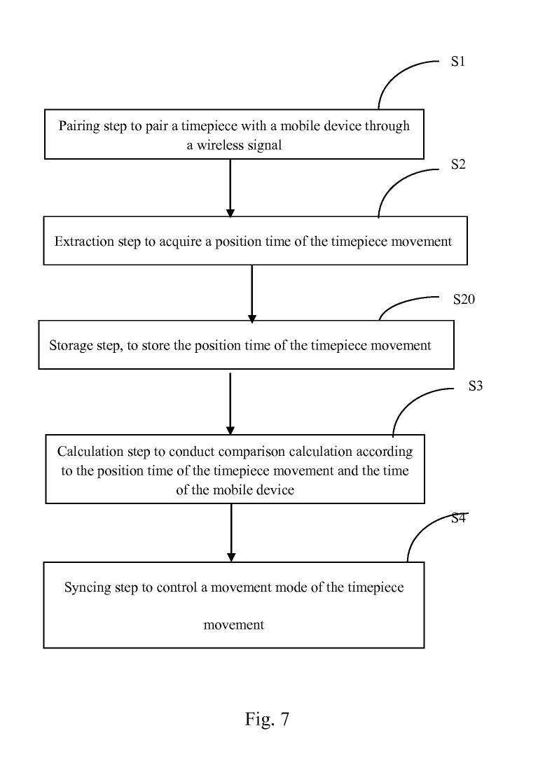

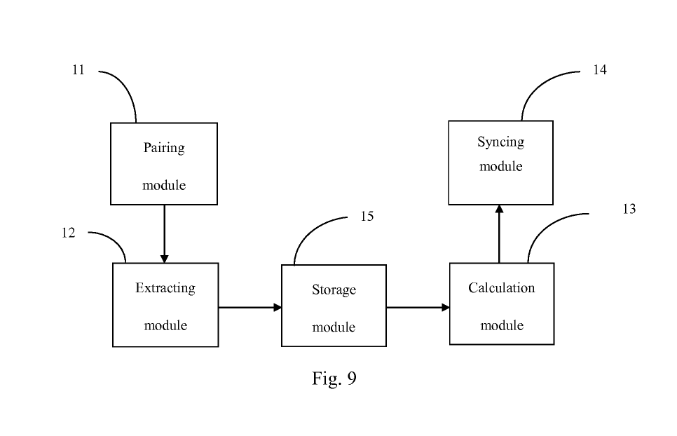

As shown in FIG. 7 and FIG. 9, the method and apparatus for adjustment of analog movement hands of a timepiece according to the embodiment includes the following steps.

S1 is a pairing step: the pairing module 11 of the timepiece is configured to pair a timepiece with a mobile device through a wireless signal.

In the embodiment, the timepiece is paired with a smartphone through a Bluetooth signal.

The pairing flow between the smartphone and the device is as follows:

A mobile application and a Bluetooth of the smartphone are enabled to emit a signal for standby pairing detection;

the smartphone starts scanning and searches a Bluetooth device (timepiece) available for pairing; and

the pairing module 11 of the timepiece is enabled through a button on the timepiece, and the timepiece will buzz once. When the button is pressed for two seconds, the timepiece will beep twice transitorily and quickly. During this period, the timepiece will broadcast the Bluetooth ID thereof quickly and transitorily to complete the pairing process in a short period of time. It usually takes a few seconds for the entire pairing process, and the timepiece will beep thrice transitorily and quickly after the pairing is successful. If a matched device cannot be found in 20 seconds, the timepiece will stop searching a Bluetooth device (smartphone) available for pairing.

Step S2 is an extraction step: after step S1 is completely conducted, the position time of the timepiece movement is required to be acquired through the extraction module 12 when the timepiece has no battery power.

Step S20 is a storage step: the storage step S3 is configured to store the data of the position time of the timepiece movement acquired. The data of the position time of the timepiece movement acquired can be stored through a storage module 15 before the battery power of the timepiece is completely exhausted.

Step S3 is a calculation step: when the timepiece is charged and after the timepiece is paired with the mobile device again, the calculation module 13 conducts comparison calculation on the data of the residence position and the time of the mobile device stored by the storage module 15 before the battery power of the timepiece is completely exhausted.

Step S4 is a syncing step: a movement mode of the timepiece movement is controlled through the syncing module 14 according to the differential value calculated after step S4 is completely conducted.

### Seventh Embodiment

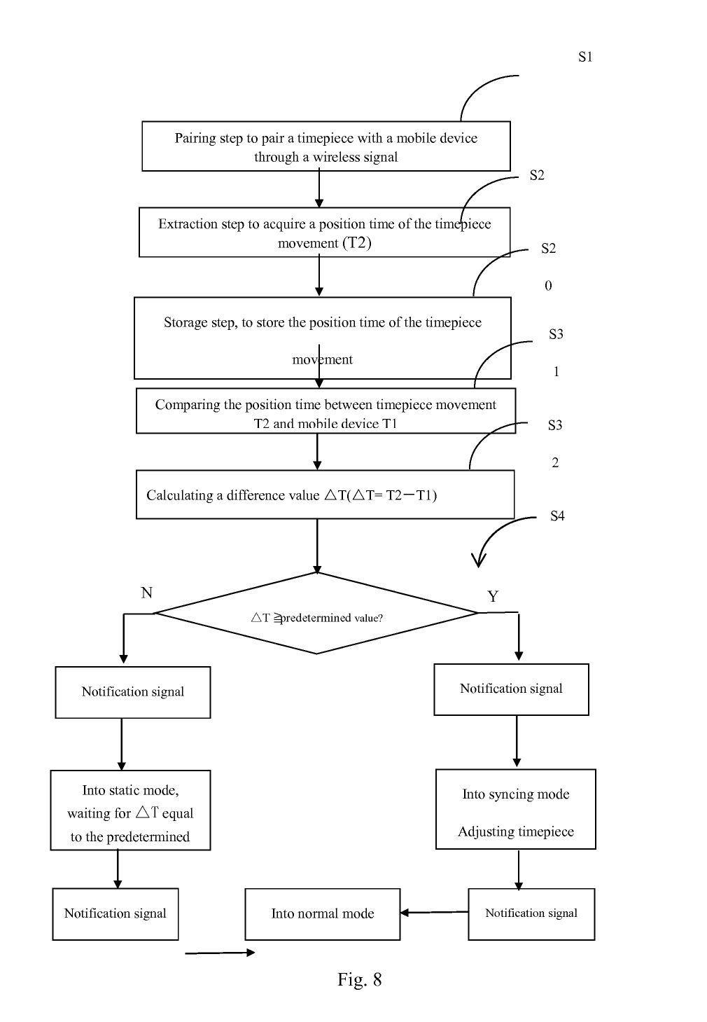

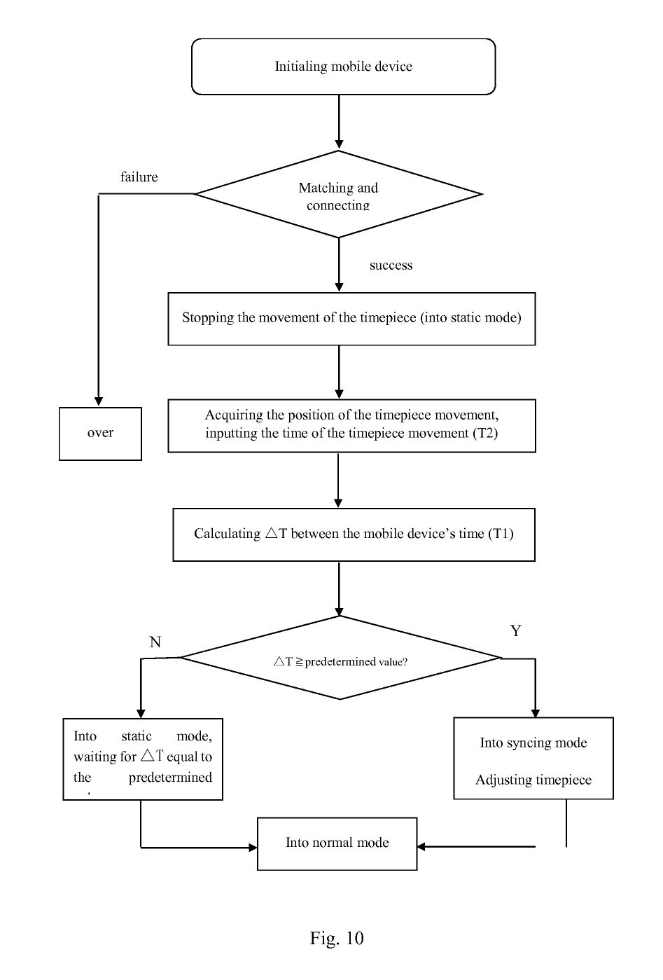

Referring to FIG. 8, FIG. 9 and FIG. 10, the method and apparatus for adjustment of analog movement hands of a timepiece according to the embodiment includes the following steps.

Step 1 is a pairing step to pair a timepiece with a mobile device through a wireless signal.

The pairing module 11 is configured to pair a timepiece with a mobile device through a wireless signal.

In the embodiment, the timepiece is paired with a smartphone through a Bluetooth signal.

The pairing flow between the smartphone and the device is as follows:

a mobile application and a Bluetooth of the smartphone are enabled to emit a signal for standby pairing detection;

the smartphone starts scanning and searches a Bluetooth device (timepiece) available for pairing; and

the pairing module 11 of the timepiece is enabled through a button on the timepiece, and the timepiece will buzz once. When the button is pressed for two seconds, the timepiece will beep twice transitorily and quickly. During this period, the timepiece will broadcast the Bluetooth ID thereof quickly and transitorily to complete the pairing process in a short period of time. It usually takes a few seconds for the entire pairing process, and the timepiece will beep thrice transitorily and quickly after the pairing is successful. If a matched device cannot be found in 20 seconds, the timepiece will stop searching a Bluetooth device (smartphone) available for pairing.

Step S2 is an extraction step to acquire the position time of the timepiece movement.

After step S1 is completely conducted, the position time of the timepiece movement is required to be acquired through the extraction module 12 when the timepiece has no battery power. The residence position time of the timepiece movement is detected visually or read through a camera lens of the mobile device, and the position time of the timepiece movement acquired is inputted to the storage module 15.

In order to accurately acquire the residence position time of the timepiece movement, in the embodiment, the camera lens focus in a position opposite to the front side of the timepiece movement, acquires the residence position of the timepiece movement, and calculates the residence time of the timepiece.

Step S20 is a storage step configured to store the data of the position time of the timepiece movement (T2) acquired. The data of the position time of the timepiece movement acquired can be stored through the storage module 15 before the battery power of the timepiece is completely exhausted.

Step S3 is a calculation step: when the timepiece is charged and after the timepiece is paired with the mobile device again, the calculation module 13 extracts the data of the residence position (T2) stored by the storage module 15 before the battery power of the timepiece is completely exhausted and compares T2 with the time of the mobile device (T1) (Step S31), calculates a differential value ΔT between the position time of the timepiece movement acquired and the time of the mobile device according to a formula ΔT=T2−T1 (Step S32), wherein the differential value ΔT is a time error of each unit time. For example, it is assumed that the position time of the timepiece movement T2 is 10:20, the time of the mobile device T1 is 10:28, then the differential value ΔT calculated according to the formula ΔT=T2−T1 is 8 minutes.

Step S4 is a syncing step to control a movement mode of the timepiece movement through the syncing module 14 according to a differential value calculated after step S4 is completely conducted.

To be specific, the movement mode of the timepiece movement of the embodiment firstly includes: a normal mode, the timepiece movement moving according to a default speed; a static mode, the timepiece movement entering a movement stopping state; and a syncing mode, the timepiece movement entering a quick rotation state.

the timepiece of the embodiment generates a timepiece movement control instruction according to the numerical value of the differential value ΔT.

When the differential value ΔT is equal to or greater than a predetermined value, the timepiece movement control instruction is conducted, and the timepiece emits a notification signal at the same time. The syncing module 14 controls to switch the movement mode of the timepiece movement to the syncing mode, and controls to switch the movement mode of the timepiece movement from the syncing mode to the normal mode after the movement of the timepiece movement is consistent with the time T1. The timepiece emits a notification signal again at the same time. In the embodiment, the predetermined value is 10 minutes. For example, it is assumed that the position time of the timepiece movement T2 is 10:20, the time of the mobile device T1 is 10:38, then the differential value ΔT calculated according to the formula ΔT=T2−T1 is 18 minutes. Since the differential value ΔT of the comparison calculation is greater than the predetermined value, the syncing module 14 controls to switch the movement mode of the timepiece movement to the syncing mode. At this moment, the timepiece will beep once, and the timepiece movement enters a quick rotating state, so that the syncing module 14 controls to switch the movement mode of the timepiece movement from the syncing mode to the normal mode after the timepiece movement moves clockwise from the time position 10:20 (T2) before switching to the syncing mode to a time position consistent with the time position 10:38 (T1). At this moment, the timepiece movement moves at a default speed, and the timepiece will beep transitorily and quickly to notify that the time calibration is completed. Similar to the foregoing description, it is assumed that the position time of the timepiece movement T2′ is 10:38, the time of the mobile device T1′ is 10:20, then the differential value ΔT′ calculated according to the formula ΔT′=T2′−T1′ is still 18 minutes. But a position relationship between the time of the timepiece movement and the time of the mobile device is changed. It may be derived from the positive and negative values of the differential value ΔT′ that the time position of the timepiece movement is in a hysteretic state relative to the time position of the mobile device. Therefore, when the conducting module 14 controls to switch the movement mode of the timepiece movement to the syncing mode, the timepiece movement moves anticlockwise from the time position 10:38 (T2′) before switching to the syncing mode to a time position consistent with the time position 10:20 (T1′), thus saving the time for adjusting and moving the timepiece movement.

When the differential value ΔT is less than the predetermined value, the timepiece movement control instruction is conducted, and the timepiece emits a notification signal at the same time. The syncing module 14 controls to switch the movement mode of the timepiece movement to the static mode, and controls to switch the movement mode of the timepiece movement from the static mode to the normal mode after waiting for a time value equal to the differential value ΔT, and the timepiece emits a notification signal again at the same time. In the embodiment, the predetermined value is 10 minutes. For example, it is assumed that the position time of the timepiece movement T2 is 10:33, the time of the mobile device T1 is 10:28, then the differential value ΔT calculated according to the formula ΔT=T2−T1 is 5 minutes. Since the differential value ΔT of the comparison calculation is less than the predetermined value, the syncing module 14 controls to switch the movement mode of the timepiece movement to the static mode. At this moment, the timepiece will beep once, and enter a movement stopping state. After the syncing module 14 waits for a time modulus (5 min) equal to the differential value ΔT, the time of the mobile device T1 at this moment is 10:33. The syncing module 14 controls to switch the movement mode of the timepiece movement from the static mode to the normal mode so that the timepiece movement moves at a default speed. At this moment, the timepiece will beep transitorily and quickly to notify that the time calibration is completed.

It may be understood by those having ordinary skills in the art that the all or part steps of implementing the foregoing embodiments may be completed through relevant hardware instructed by a program. The program may be stored in a mobile device or a computer readable storage medium, and the program while conducting includes one or a combination of the steps of the embodiments of the method. Moreover, each function unit in each embodiment of the present invention may be integrated in one processing module, or each unit exists singly and physically, or two or more than two units are integrated in one module. The foregoing integrated module may either be fulfilled using a hardware form, or be fulfilled using a software functional module form.

It should be noted that the above embodiments are for purposes of illustration to the technical solution of the present invention merely, but are not intended to limit the present invention. Although detailed illustration is made to the present invention with reference to preferred embodiments, it may be understood by those having ordinary skills in the art that modification or equivalent replacement may be conducted on the technical solution of the present invention without departing from the spirit and scope of the technical solution of the present invention, which shall all fall within the scope of the claims of the present invention.

What is claimed is:

1. A method for adjustment of analog movement hands of a timepiece, comprising the steps of:
a pairing step to pair a timepiece with a mobile device through a wireless signal;
an extraction step to acquire the position time of the timepiece movement;
a calculation step to conduct comparison calculation according to the position time of the timepiece movement and the time of the mobile device; and
a syncing step to control a movement mode of the timepiece movement according to a differential value of the comparison calculation.

2. The method for adjustment of analog movement hands of a timepiece of claim 1, wherein the extraction step further comprises:
transmitting the position time of the timepiece movement acquired to the mobile device after stopping the movement of the timepiece movement and acquiring the position time of the timepiece movement.

3. The method for adjustment of analog movement hands of a timepiece of claim 1, wherein the calculation step further comprises:
conducting comparison according to the position time of the timepiece movement T2 acquired and the time of the mobile device T1, and calculating a differential value ΔT between the position time of the timepiece movement acquired and the time of the mobile device according to a formula ΔT=T2−T1, wherein the differential value ΔT is a time error of each unit time.

4. The method for adjustment of analog movement hands of a timepiece of claim 2, wherein the calculation step further comprises:
conducting comparison according to the position time of the timepiece movement T2 acquired and the time of the mobile device T1, and calculating a differential value ΔT between the position time of the timepiece movement acquired and the time of the mobile device according to a formula ΔT=T2−T1, wherein the differential value ΔT is a time error of each unit time.

5. The method for adjustment of analog movement hands of a timepiece of claim 3, wherein the movement mode of the timepiece movement comprises:
a normal mode, the timepiece movement moving according to a default speed;
a static mode, the timepiece movement entering a movement stopping state; and
a syncing mode, the timepiece movement entering a quick rotation state; and
the syncing step further comprises:
generating a timepiece movement control instruction according to the differential value ΔT;
when the differential value ΔT is equal to or greater than a predetermined value, conducting the timepiece movement control instruction and controlling to switch the movement mode of the timepiece movement to the syncing mode, and controlling to switch the movement mode of the timepiece movement from the syncing mode to the normal mode after the movement of the timepiece is consistent with the time T1; and
when the differential value ΔT is less than the predetermined value, conducting the timepiece movement control instruction and controlling to switch the movement mode of the timepiece movement to the static mode, and controlling to switch the movement mode of the timepiece movement from the static mode to the normal mode after waiting for a time value equal to the differential value ΔT.

6. The method for adjustment of analog movement hands of a timepiece of claim 5, further comprising a storage step to store the data of the position time of the timepiece movement acquired.

7. The method for adjustment of analog movement hands of a timepiece of claim 6, wherein the syncing step further comprises:
emitting, by the timepiece, a notification signal when conducting the timepiece movement control instruction; and meanwhile, emitting, by the timepiece, a notification signal again when the movement mode of the timepiece movement is restored to the normal mode; the notification signal being presented by at least one manner of sound, device vibration or flashing light.

8. An apparatus for adjustment of analog movement hands of a timepiece, comprising:
a pairing module configured to pair a timepiece with a mobile device through a wireless signal;
an extraction module configured to acquire the position time of the timepiece movement;
a calculation module configured to conduct comparison calculation according to the position time of the timepiece movement and the time of the mobile device; and
a syncing module configured to control a movement mode of the timepiece movement according to a differential value of the comparison calculation.

9. The apparatus for adjustment of analog movement hands of a timepiece of claim 8, wherein the extraction module is further configured to transmit the position time of the timepiece movement acquired to the mobile device after stopping the movement of the timepiece and acquiring the position time of the timepiece movement.

10. The apparatus for adjustment of analog movement hands of a timepiece of claim 8, wherein the calculation module conducts comparison according to the position time of the timepiece movement T2 acquired and the time of the mobile device T1, and calculates a differential value ΔT between the position time of the timepiece movement acquired and the time of the mobile device according to a formula ΔT=T2−T1, wherein the differential value ΔT is a time error of each unit time.

11. The apparatus for adjustment of analog movement hands of a timepiece of claim 9, wherein the calculation module conducts comparison according to the position time of the timepiece movement T2 acquired and the time of the mobile device T1, and calculates a differential value ΔT between the position time of the timepiece movement acquired and the time of the mobile device according to a formula ΔT=T2−T1, wherein the differential value ΔT is a time error of each unit time.

12. The apparatus for adjustment of analog movement hands of a timepiece according to claim 10, wherein the movement mode of the timepiece movement comprises:
a normal mode, the timepiece movement moving according to a default speed;
a static mode, the timepiece movement entering a movement stopping state; and
a syncing mode, the timepiece movement entering a quick rotation state; and
the syncing module is configured to:
generate a timepiece movement control instruction according to the differential value ΔT;
when the differential value ΔT is equal to or greater than a predetermined value, conduct the timepiece movement control instruction and control to switch the movement mode of the timepiece movement to the syncing mode, and control to switch the movement mode of the timepiece movement from the syncing mode to the normal mode after the movement of the timepiece movement is consistent with the time T1; and
when the differential value ΔT is less than the predetermined value, conduct the timepiece movement control instruction and control to switch the movement mode of the timepiece movement to the static mode, and control to switch the movement mode of the timepiece movement from the static mode to the normal mode after waiting for a time value equal to the differential value ΔT.

13. The apparatus for adjustment of analog movement hands of a timepiece of claim 12, wherein the apparatus for adjustment of analog movement hands of a timepiece further comprises a storage module configured to store the data of the position time of the timepiece movement acquired.

14. The apparatus for adjustment of analog movement hands of a timepiece of claim 13, wherein the syncing module is further configured to:
emit, by the timepiece, a notification signal when conducting the timepiece movement control instruction; and meanwhile, emit, by the timepiece, a notification signal again when the movement mode of the timepiece movement is restored to the normal mode; the notification signal being presented by at least one manner of sound, device vibration or flashing light.
